(19) United States
(12) Patent Application Publication
(10) Pub. No.: US 2017/0363654 A1
(43) Pub. Date: Dec. 21, 2017

(54) ACCELERATION DETECTION DEVICE AND MANUFACTURING METHOD THEREOF

(71) Applicant: Murata Manufacturing Co., Ltd., Nagaokakyo-shi (JP)

(72) Inventor: Hirotoshi HATAKEYAMA, Nagaokakyo-shi (JP)

(21) Appl. No.: 15/691,933

(22) Filed: Aug. 31, 2017

Related U.S. Application Data
(63) Continuation of application No. PCT/JP2015/079456, filed on Oct. 19, 2015.

(30) Foreign Application Priority Data
Mar. 12, 2015 (JP) 2015-049860

(51) Int. Cl. G01P 15/09; G01P 15/08

(52) U.S. Cl. CPC G01P 15/09; G01P 15/0802

(57) ABSTRACT

An acceleration detection device includes a piezoelectric element including a top surface and a bottom surface, a sheet-shaped adhesive provided on the bottom surface of the piezoelectric element, and a first package member to which the piezoelectric element is bonded by the sheet-shaped adhesive.

### CROSS REFERENCE TO RELATED APPLICATIONS

This application claims the benefit of priority to Japanese Patent Application No. 2015-049860 filed on Mar. 12, 2015 and is a Continuation application of PCT Application No. PCT/JP2015/079456 filed on Oct. 19, 2015. The entire contents of each application are hereby incorporated herein by reference.

### BACKGROUND OF THE INVENTION

### 1. Field of the Invention

The present invention relates to an acceleration detection device fixed to a package member, and to a method of manufacturing such a device.

### 2. Description of the Related Art

Japanese Patent No. 4190208 discloses an example of an acceleration detection device. In this acceleration detection device, a piezoelectric element is supported by being enclosed in a support frame.

Also, in an acceleration detection device disclosed in Japanese Patent No. 3183177, a piezoelectric element is supported by being enclosed in a case member.

In Japanese Unexamined Patent Application Publication No. 2001-074768, a piezoelectric element is fixed to a base member using an instant adhesive and a conductive adhesive.

In Japanese Unexamined Patent Application Publication No. 7-202283, a piezoelectric element is enclosed in an element attachment portion of a case member. Furthermore, the piezoelectric element is fixed using a conductive adhesive and an insulative adhesive.

In the acceleration detection devices according to Japanese Patent No. 4190208 and Japanese Patent No. 3183177, the piezoelectric element is supported strongly by being directly enclosed in the support frame or the case member. Accordingly, the acceleration detection device is susceptible to the effects of noise produced by the support frame, the case member, or other bending.

In the acceleration detection device according to Japanese Unexamined Patent Application Publication No. 2001-074768, the effects of gravity on the piezoelectric element before the instant adhesive and the conductive adhesive solidify makes it easy for the position and holding angle of the piezoelectric element to shift. Furthermore, the instant adhesive and the conductive adhesive expand or shrink significantly during solidification. This also makes it easy for the position and holding angle of the piezoelectric element to shift.

Also, in the acceleration detection device according to Japanese Unexamined Patent Application Publication No. 7-202283, expansion or shrinkage when the conductive adhesive and the insulative adhesive solidify makes it easy for the position and holding angle of the piezoelectric element to shift. Furthermore, the piezoelectric element is enclosed by the element attachment portion, and thus, the acceleration detection device is susceptible to the effects of noise produced by the case member or other bending.

### SUMMARY OF THE INVENTION

Preferred embodiments of the present invention provide acceleration detection devices in which a position and a holding angle of a piezoelectric element do not easily shift and the devices are not susceptible to the effects of noise, and also provide methods of manufacturing such a device.

An acceleration detection device according to a preferred embodiment of the present invention includes a piezoelectric element including a top surface and a bottom surface; a sheet-shaped adhesive provided on the bottom surface of the piezoelectric element; and a first package member to which the piezoelectric element is bonded by the sheet-shaped adhesive.

In an acceleration detection device according to a preferred embodiment of the present invention, the piezoelectric element includes a piezoelectric member and first and second electrodes provided on the piezoelectric member; and the piezoelectric member includes a top surface, a bottom surface, a first side surface, and a second side surface opposing the first side surface. In this case, it is easy to make an electrical connection with the exterior.

In an acceleration detection device according to a preferred embodiment of the present invention, the first electrode is provided on the first side surface of the piezoelectric member, and the second electrode is provided on the second side surface of the piezoelectric member. In this case, it is easy to make an electrical connection with the exterior.

In an acceleration detection device according to a preferred embodiment of the present invention, the first electrode is provided on the bottom surface of the piezoelectric member, and the second electrode is provided on the top surface of the piezoelectric member. In this case, it is easy to make an electrical connection with the exterior.

In an acceleration detection device according to another preferred embodiment of the present invention, the piezoelectric element preferably includes a first extended electrode, connected to the first electrode and provided on the first side surface of the piezoelectric member, and a second extended electrode, connected to the second electrode and provided on the second side surface of the piezoelectric member. In this case, it is easy to make an electrical connection with the exterior.

In an acceleration detection device according to another preferred embodiment of the present invention, a top surface and a bottom surface of a piezoelectric element extend in a longitudinal direction, and the piezoelectric element is fixed by the sheet-shaped adhesive such that the piezoelectric element includes a free end in at least one location. In this case, it is even more difficult for the position and holding angle of the piezoelectric element to shift, and the piezoelectric element is even less susceptible to the effects of noise.

In an acceleration detection device according to another preferred embodiment of the present invention, the piezoelectric element is supported in a cantilever state by the sheet-shaped adhesive. In this case, it is even more difficult for the position and holding angle of the piezoelectric element to shift, and the piezoelectric element is even less susceptible to the effects of noise.

In an acceleration detection device according to another preferred embodiment of the present invention, the sheet-shaped adhesive extends into one end portion of the piezoelectric element in the longitudinal direction of the piezoelectric element. In this case, the sensitivity is able to be effectively increased.

In an acceleration detection device according to another preferred embodiment of the present invention, the acceleration detection device preferably further includes first and second inner electrodes that are provided within the piezoelectric element and that oppose each other. In this case, the electrostatic capacitance is high. This also makes it possible to effectively increase the sensitivity.

In an acceleration detection device according to another preferred embodiment of the present invention, the sheet-shaped adhesive is made of an insulative material. In this case, the first electrode and the second electrode are able to be reliably electrically insulated from each other.

In an acceleration detection device according to another preferred embodiment of the present invention, the acceleration detection device further includes a second package member bonded to the first package member, and the piezoelectric element is sealed by the first and second package members. In this case, the strength is able to be increased, and the device is not susceptible to the effects of noise from the exterior.

In an acceleration detection device according to another preferred embodiment of the present invention, the first package member has a flat plate shape and the second package member has a cap shape. In this case, the strength is able to be increased, and the device is not susceptible to the effects of noise from the exterior.

In an acceleration detection device according to another preferred embodiment of the present invention, the first package member includes a recess, and the piezoelectric element is disposed within the recess and the second package member is provided to cover the recess so as to seal the piezoelectric element. In this case, the strength is able to be increased, and the device is not susceptible to the effects of noise from the exterior.

A method of manufacturing an acceleration detection device according to a preferred embodiment of the present invention includes preparing a piezoelectric element; affixing a sheet-shaped adhesive to a bottom surface of the piezoelectric element; and bonding the piezoelectric element to a first package member using the sheet-shaped adhesive. In this case, it is possible to obtain an acceleration detection device in which it is even more difficult for the position and holding angle of the piezoelectric element to shift, and the piezoelectric element is even less susceptible to the effects of noise.

According to various preferred embodiments of the present invention, acceleration detection devices in which the position and holding angle of a piezoelectric element do not easily shift and that are not susceptible to the effects of noise, as well as methods of manufacturing such devices, are provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a plan view of an acceleration detection device according to a first preferred embodiment of the present invention, illustrating the acceleration detection device without a second package member; FIG. 1B is a diagram illustrating the acceleration detection device, without the second package member, from the side of a first side surface of a piezoelectric member, according to the first preferred embodiment of the present invention; FIG. 1C is a diagram illustrating the acceleration detection device, without the second package member, from the side of a second side surface of the piezoelectric member, according to the first preferred embodiment of the present invention; and FIG. 1D is a cross-sectional view of the acceleration detection device, without the second package member, viewed along a line A-A in FIG. 1A.

FIG. 2A is a perspective view of the acceleration detection device according to the first preferred embodiment of the present invention, and FIG. 2B is an exploded perspective view of the acceleration detection device according to the first preferred embodiment of the present invention.

FIG. 3A to FIG. 3D are perspective views illustrating an example of a method of manufacturing the acceleration detection device according to the first preferred embodiment of the present invention.

FIG. 4 is a plan view of an acceleration detection device according to a first variation of the first preferred embodiment of the present invention, illustrating the acceleration detection device without the second package member.

FIG. 5A is a plan view of an acceleration detection device according to a second variation of the first preferred embodiment of the present invention, illustrating the acceleration detection device without the second package member; and FIG. 5B is a cross-sectional view of the acceleration detection device viewed along a line B-B in FIG. 5A, illustrating the acceleration detection device without the second package member.

FIG. 6A is a plan view of an acceleration detection device according to a third variation of the first preferred embodiment of the present invention, illustrating the acceleration detection device without the second package member; and FIG. 6B is a cross-sectional view of the acceleration detection device viewed along a line C-C in FIG. 6A, illustrating the acceleration detection device without the second package member.

FIG. 7A is a plan view of an acceleration detection device according to a fourth variation of the first preferred embodiment of the present invention, illustrating the acceleration detection device without the second package member; and FIG. 7B is a diagram illustrating the acceleration detection device, without the second package member, from the side of the second side surface of the piezoelectric member, according to the first preferred embodiment of the present invention.

FIG. 8 is a plan view of an acceleration detection device according to a fifth variation of the first preferred embodiment of the present invention, illustrating the acceleration detection device without the second package member.

FIG. 9A is a plan view of an acceleration detection device according to a second preferred embodiment of the present invention, illustrating the acceleration detection device without the second package member; FIG. 9B is a diagram illustrating the acceleration detection device, without the second package member, from the side of the first side surface of the piezoelectric member, according to the second preferred embodiment of the present invention; and FIG. 9C is a diagram illustrating the acceleration detection device, without the second package member, from the side of the second side surface of the piezoelectric member, according to the second preferred embodiment of the present invention.

FIG. 10 is a plan view of an acceleration detection device according to a first variation of the second preferred embodiment of the present invention, illustrating the acceleration detection device without the second package member.

FIG. 11A is a plan view of an acceleration detection device according to a third preferred embodiment of the present invention, illustrating the acceleration detection device without the second package member; FIG. 11B is a diagram illustrating the acceleration detection device, without the second package member, from the side of the first side surface of the piezoelectric member, according to the third preferred embodiment of the present invention; FIG. 11C is a diagram illustrating the acceleration detection device, without the second package member, from the side of the second side surface of the piezoelectric member, according to the third preferred embodiment of the present invention; and FIG. 11D is a cross-sectional view of the acceleration detection device, without the second package member, viewed along a line D-D in FIG. 11A.

FIG. 12A is a plan view of an acceleration detection device according to a sixth variation of the first preferred embodiment of the present invention, illustrating the acceleration detection device without the second package member; and FIG. 12B is a cross-sectional view of the acceleration detection device viewed along a line E-E in FIG. 12A, illustrating the acceleration detection device without the second package member.

FIG. 13A is a plan view of an acceleration detection device according to a first variation of the third preferred embodiment of the present invention; FIG. 13B is a plan view of the acceleration detection device according to the eighth variation, without the second package member; and FIG. 13C is a diagram illustrating the acceleration detection device from the side of the first side surface of the piezoelectric member according to the eighth variation, without the second package member.

FIG. 14 is a schematic plan view of an electrode structure on a bottom surface of a first package member according to the first variation of the third preferred embodiment of the present invention.

FIG. 15 is a plan view of an acceleration detection device according to a second variation of the third preferred embodiment of the present invention, illustrating the acceleration detection device without the second package member.

FIG. 16 is a side cross-sectional view of an acceleration detection device according to a fourth preferred embodiment of the present invention.

### DETAILED DESCRIPTION OF THE PREFERRED EMBODIMENTS

The present invention will be described with reference to specific preferred embodiments of the present invention and to the drawings.

Note that the various preferred embodiments disclosed in the present specification are merely examples, and it is to be understood that partial replacements or combinations of configurations among different preferred embodiments are also possible.

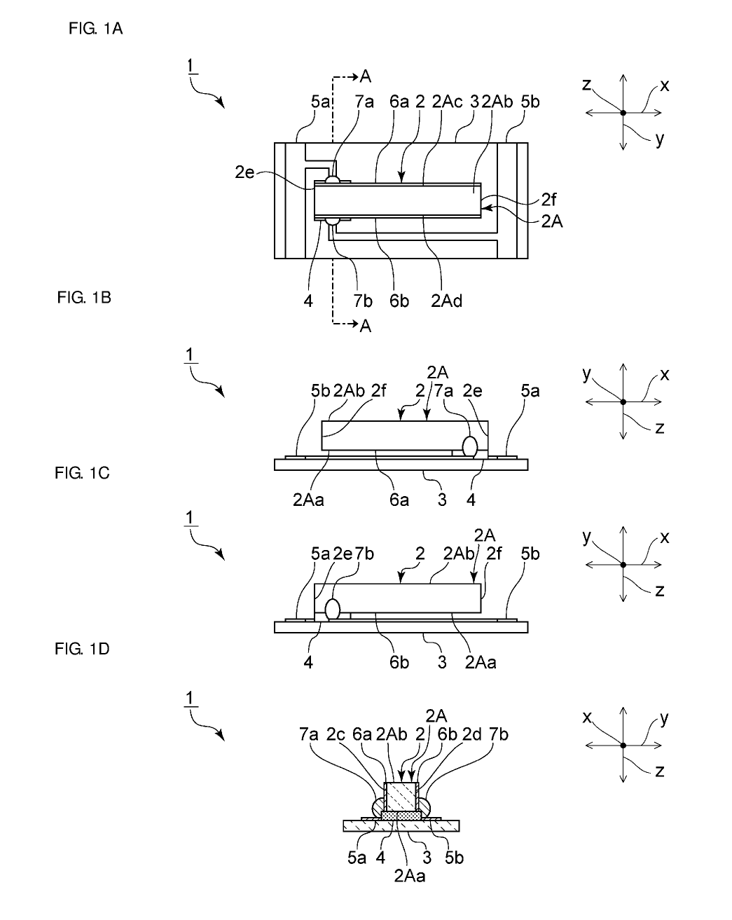

FIG. 1A is a plan view of an acceleration detection device according to a first preferred embodiment of the present invention. FIG. 1B is a diagram illustrating the acceleration detection device from the side of a first side surface of a piezoelectric member, according to the first preferred embodiment. FIG. 1C is a diagram illustrating the acceleration detection device from the side of a second side surface of the piezoelectric member, according to the first preferred embodiment. FIG. 1D is a cross-sectional view of the acceleration detection device, viewed along the line A-A in FIG. 1A. Note that a second package member, which will be described later, is not illustrated in FIGS. 1A to 1D.

As illustrated in FIG. 1A, an acceleration detection device 1 includes a first package member 3. The first package member 3 has a flat plate shape. Although not particularly limited, the first package member 3 may preferably be made of glass epoxy resin, for example. The first package member 3 may instead be made of a suitable ceramic material.

First and second wires 5a and 5b are provided on the first package member 3. Furthermore, a sheet-shaped adhesive 4 is provided on the first package member 3. As illustrated in FIGS. 1B and 1C, a piezoelectric element 2 is bonded to the first package member 3 by the sheet-shaped adhesive 4. The sheet-shaped adhesive is preferably made of an insulative material, such as epoxy resin, for example. Note that the material of the sheet-shaped adhesive 4 is not particularly limited.

As illustrated in FIGS. 1A and 1D, the piezoelectric element 2 includes a piezoelectric member 2A and first and second electrodes 6a and 6b. The piezoelectric member 2A preferably has a rectangular or substantially rectangular parallelepiped shape with a longitudinal direction. The piezoelectric member 2A includes a bottom surface 2Aa and a top surface 2Ab extending in the longitudinal direction. Furthermore, the piezoelectric member 2A includes a first side surface 2Ac extending in the longitudinal direction and a second side surface 2Ad opposing the first side surface 2Ac. The piezoelectric member 2A is preferably made of a piezoelectric single-crystal, piezoelectric ceramics, or other suitable piezoelectric materials, for example. In the present preferred embodiment, the piezoelectric member 2A is preferably a single-layer piezoelectric member. Note that the piezoelectric element 2 may include a plurality of piezoelectric member layers.

The first electrode 6a is provided on the first side surface 2Ac of the piezoelectric member 2A. The second electrode 6b is provided on the second side surface 2Ad of the piezoelectric member 2A.

The piezoelectric element 2 is bonded onto the first package member 3 using the sheet-shaped adhesive 4, which is provided on the bottom surface 2Aa of the piezoelectric element 2. In other words, the piezoelectric element 2 is bonded onto the first package member 3 from the bottom surface 2Aa side of the piezoelectric member 2A.

As illustrated in FIGS. 1A and 1B, the piezoelectric element 2 includes a first end portion 2e corresponding to one end portion in the longitudinal direction. The piezoelectric element 2 also includes a second end portion 2f opposing the first end portion 2e. The piezoelectric element 2 is supported in a cantilever state on the first end portion 2e side by the sheet-shaped adhesive 4. The second end portion 2f corresponds to a free end of the piezoelectric element 2. The sheet-shaped adhesive 4 extends to the first end portion 2e. However, the sheet-shaped adhesive 4 need not extend to the first end portion 2e.

As illustrated in FIGS. 1A and 1D, the first electrode 6a is electrically connected to a first wire 5a by a conductive adhesive 7a. The second electrode 6b is also electrically connected to a second wire 5b by a conductive adhesive 7b. As a result, the piezoelectric element 2 is electrically connected to the exterior.

The conductive adhesives 7a and 7b are provided in positions overlapping with the sheet-shaped adhesive 4 when viewed in plan view from the top surface 2Ab side of the piezoelectric element 2. Note that the positions where the first and second electrodes 6a and 6b are connected to the first and second wires 5a and 5b by the conductive adhesives 7a and 7b are not particularly limited. The conductive adhesives 7a and 7b are not particularly limited, and a Si-based adhesive containing a conductor may preferably be used, for example.

As illustrated in FIGS. 1A to 1D, the longitudinal direction of the piezoelectric element 2 is taken as an x direction. A direction perpendicular or substantially perpendicular to the longitudinal direction of the piezoelectric element 2 is taken as a y direction. A direction perpendicular or substantially perpendicular to an x-y plane is taken as a z direction. Here, the surface of the first package member 3 to which the piezoelectric element 2 is bonded is parallel or substantially parallel to the x-y plane. The first and second electrodes 6a and 6b oppose each other with respect to the y direction. In other words, a main axis direction of the acceleration detection device 1 is 0⁰ or approximately 0⁰ relative to the x-y plane.

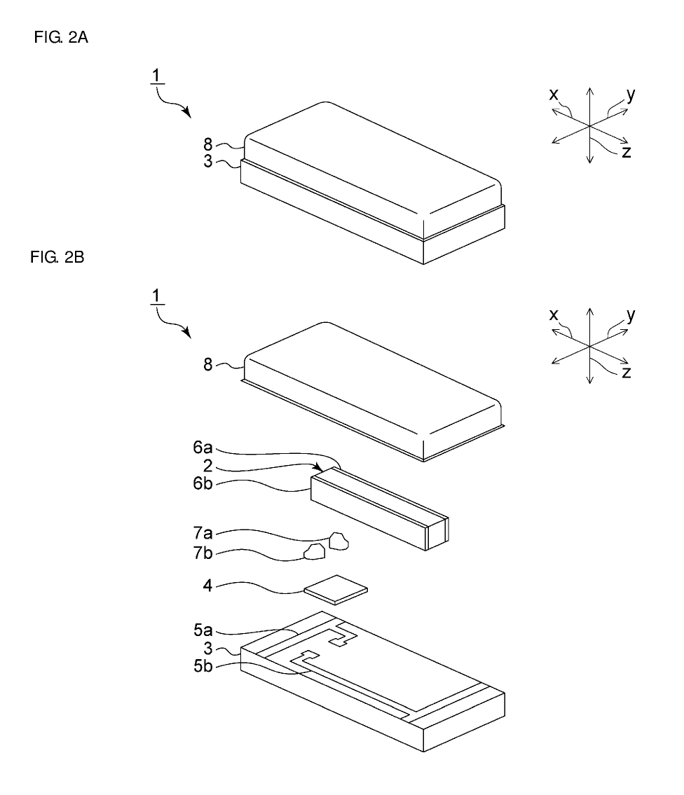

FIG. 2A is a perspective view of the acceleration detection device according to the first preferred embodiment of the present invention. FIG. 2B is an exploded perspective view of the acceleration detection device according to the first preferred embodiment.

As illustrated in FIG. 2A, the acceleration detection device 1 includes a second package member 8 bonded on top of the first package member 3. The second package member 8 preferably has a cap shape. As illustrated in FIGS. 2A and 2B, the piezoelectric element 2 is sealed by the first package member 3 and the second package member 8.

The acceleration detection device 1 does not absolutely require the second package member 8. However, it is preferable that the piezoelectric element 2 be sealed by the first package member 3 and the second package member 8. Doing so increases the strength of the acceleration detection device 1 and makes the acceleration detection device 1 less susceptible to the effects of mechanical noise from the exterior. Additionally, making the second package member from a metal and setting a potential thereof to a ground potential makes the acceleration detection device 1 less susceptible to the effects of electromagnetic noise. Note that the material of the second package member 8 is not particularly limited, and may preferably be a ceramic material, for example.

One of the unique characteristics of the acceleration detection device 1 according to the present preferred embodiment is that the piezoelectric element 2 is bonded to the first package member 3 using the sheet-shaped adhesive 4. As a result, in the acceleration detection device 1, the position and holding angle of the piezoelectric element do not easily shift, and the element is not susceptible to the effects of noise. This will be described hereinafter.

Conventionally, in an acceleration detection device in which the piezoelectric element is supported by an adhesive, the piezoelectric element is not fully fixed before the adhesive is solidified. It has thus been easy for the holding angle of the piezoelectric element to shift due to the effects of gravity and other forces. Furthermore, the adhesive expands or shrinks when the adhesive solidifies, and the holding angle and position of the piezoelectric element are likely to shift as a result.

Alternatively, in the case where the piezoelectric element is held by being enclosed in a case member or a support member, vibrations and other forces have been transmitted easily from the case member or support member to the piezoelectric element. The devices have therefore been susceptible to the effects of noise produced by the case member or support member bending or other otherwise deforming.

As opposed to this, according to the present preferred embodiment, the piezoelectric element 2 is supported by the sheet-shaped adhesive 4, as illustrated in FIGS. 1A to 1D. The sheet-shaped adhesive 4 supports the piezoelectric element 2 with its surface. The attitude of the piezoelectric element 2 is thus able to be stabilized. Accordingly, shifting in the holding angle is effectively reduced or prevented.

The piezoelectric element 2 is bonded onto the first package member 3 using the sheet-shaped adhesive 4. Accordingly, the piezoelectric element 2 does not make direct contact with the first package member 3. Furthermore, the piezoelectric element 2 is supported at one location by the sheet-shaped adhesive 4. As such, the device is not susceptible to the effects of noise caused by bending or other deformation in the first package member 3.

As described above, the first and second electrodes 6a and 6b are provided on the first and second side surfaces 2Ac and 2Ad of the piezoelectric member 2A. The first and second electrodes 6a and 6b are electrically connected to the first and second wires 5a and 5b by the conductive adhesives 7a and 7b. Here, the conductive adhesives 7a and 7b are provided to electrically connect the first and second electrodes 6a and 6b and the first and second wires 5a and 5b, but do not provide a strong physical connection. In other words, the conductive adhesives 7a and 7b provide almost no support for the piezoelectric element 2. As such, the effects of noise caused by bending or other deformation in the first package member 3 are effectively reduced or prevented.

The piezoelectric element 2 is supported in a cantilever state. The sheet-shaped adhesive 4 extends to the first end portion 2e of the piezoelectric element 2. Accordingly, a distance between the supported portion of the piezoelectric element 2 and the second end portion 2f corresponding to the free end is able to be lengthened. This makes it possible to effectively improve the sensitivity of the acceleration detection device 1.

Furthermore, as described above, the holding angle of the piezoelectric element 2 does not shift easily, and thus, the piezoelectric element 2 does not shift easily from the main axis of the acceleration detection device 1. Accordingly, a drop in the sensitivity is effectively reduced or prevented.

The first and second electrodes 6a and 6b are provided on the first and second side surfaces 2Ac and 2Ad of the piezoelectric member 2A, and are exposed to the exterior. It is therefore easy to make an electrical connection with the exterior. Furthermore, the sheet-shaped adhesive 4 is preferably made of an insulative material, and thus the first electrode 6a and the second electrode 6b are able to be reliably electrically insulated from each other.

An example of a method of manufacturing the acceleration detection device according to the first preferred embodiment will be described hereinafter.

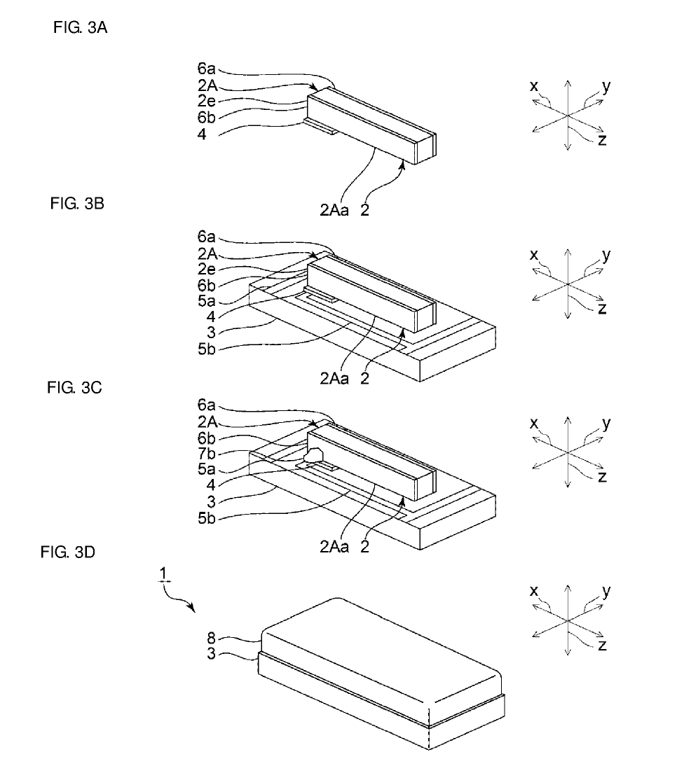

FIGS. 3A to 3D are perspective views illustrating an example of a method of manufacturing the acceleration detection device according to the first preferred embodiment.

As illustrated in FIG. 3A, the piezoelectric element 2 including the piezoelectric member 2A is prepared. Next, the sheet-shaped adhesive 4 is affixed to the bottom surface of the piezoelectric element 2. At this time, the sheet-shaped adhesive 4 is preferably affixed in a semi-solidified state, so as to extend to the first end portion 2e of the piezoelectric element 2. However, the sheet-shaped adhesive 4 may be provided in a position that does not extend to the first end portion 2e. The sheet-shaped adhesive 4 does not flow easily, and thus, the affixing position thereof is able to be easily and reliably adjusted. This makes it possible to easily and reliably adjust the sensitivity.

Next, as illustrated in FIG. 3B, the piezoelectric element 2 is bonded to the first package member 3 using the sheet-shaped adhesive 4. The piezoelectric element 2 is able to be supported on its surface by the sheet-shaped adhesive 4, and thus, the attitude of the piezoelectric element 2 is made stable. Accordingly, shifting in the holding angle is effectively reduced or prevented.

Furthermore, the sheet-shaped adhesive 4 is in a semi-solidified state during the above-described bonding. As such, the sheet-shaped adhesive 4 does not easily change the shape during solidification. Therefore, the position and holding angle of the piezoelectric element 2 do not shift easily.

Here, as described above, the first and second electrodes 6a and 6b are provided on the first and second side surfaces 2Ac and 2Ad of the piezoelectric member 2A. The first and second wires 5a and 5b are provided on the first package member 3.

Next, as illustrated in FIG. 3C, the second electrode 6b and the second wire 5b are electrically connected using the conductive adhesive 7b. Although not illustrated, the first electrode 6a and the first wire 5a are electrically connected using a conductive adhesive.

Next, as illustrated in FIG. 3D, the second package member 8 is bonded into the first package member 3 so as to seal the piezoelectric element. The acceleration detection device 1 is obtained as a result.

Incidentally, the type of electrical connections between the first and second electrodes 6a and 6b and the first and second wires 5a and 5b is not particularly limited. As in the first preferred embodiment, the position and holding angle of the piezoelectric element 2 will not shift easily even if the stated connection is of a different type. This will be described using the following first to third variations as examples.

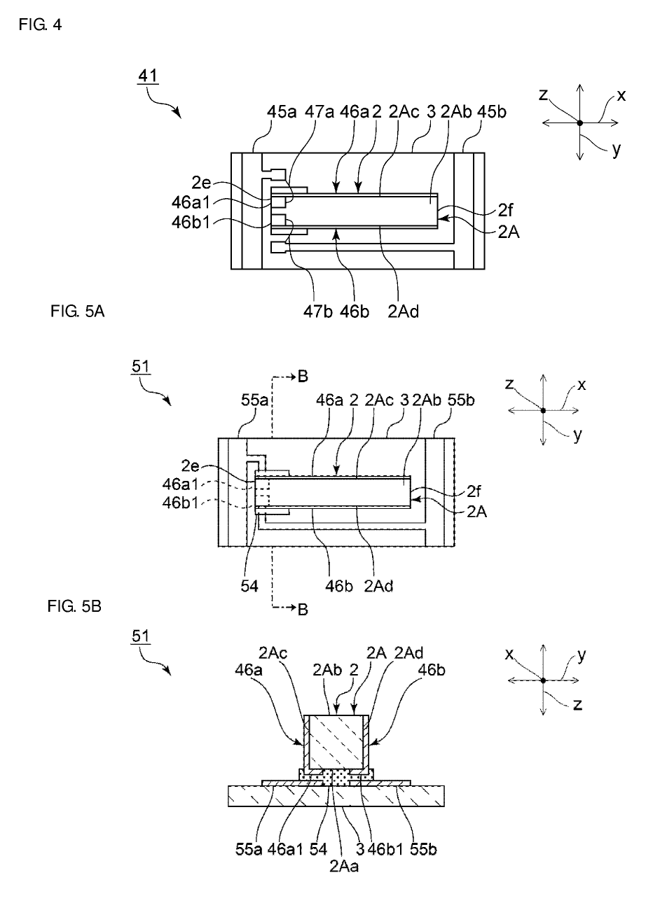

As indicated by an acceleration detection device 41 according to the first variation illustrated in FIG. 4, first and second electrodes 46a and 46b and first and second wires 45a and 45b may preferably be electrically connected by bonding wires 47a and 47b. More specifically, the first electrode 46a includes a first extended electrode 46a1 extended to the top surface 2Ab of the piezoelectric member 2A. The second electrode 46b also includes a second extended electrode 46b1 extended to the top surface 2Ab of the piezoelectric member 2A. The first extended electrode 46a1 and the first wire 45a are electrically connected by the bonding wire 47a. The second extended electrode 46b1 and the second wire 45b are electrically connected by the bonding wire 47b.

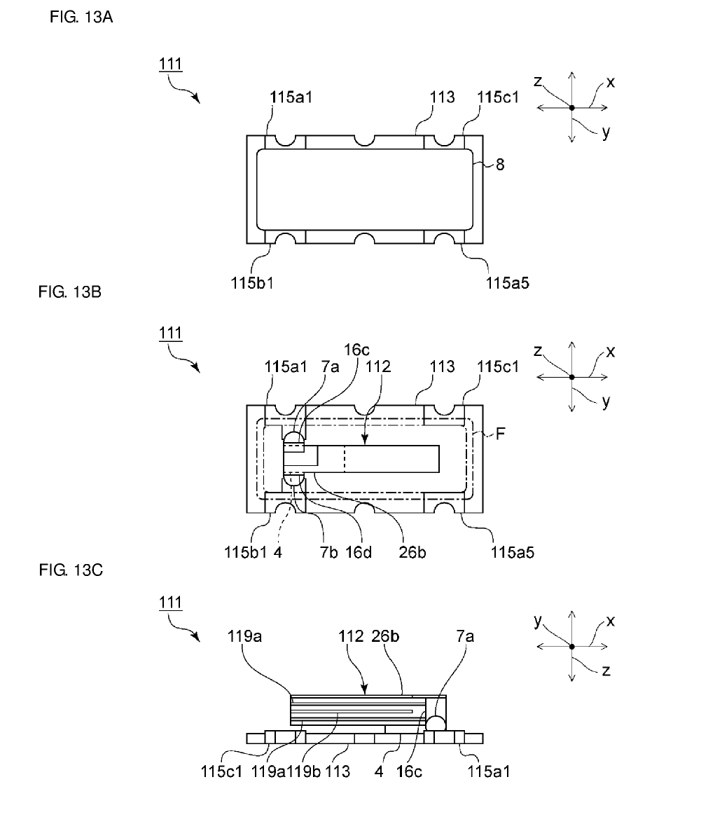

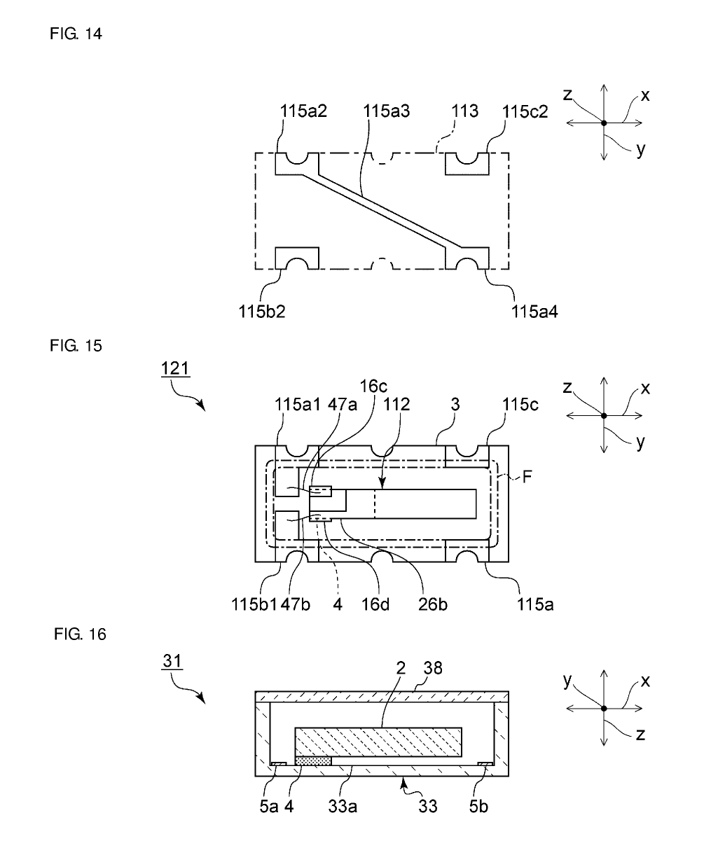

FIG. 5A is a plan view of an acceleration detection device according to the second variation of the first preferred embodiment. FIG. 5B is a cross-sectional view of the acceleration detection device, viewed along the line B-B in FIG. 5A. Note that the second package member is not illustrated in the drawings aside from the above-described FIG. 2 and FIG. 3, and FIG. 13A and FIG. 14 described below.

As illustrated in FIG. 5B, the first electrode 46a of an acceleration detection device 51 includes the first extended electrode 46a1 extended to the bottom surface 2Aa of the piezoelectric member 2A. The second electrode 46b also includes the second extended electrode 46b1 extended to the bottom surface 2Aa of the piezoelectric member 2A. As illustrated in FIGS. 5A and 5B, a first wire 55a is routed to a position overlapping with the first extended electrode 46a1, when viewed in plan view from the top surface 2Ab side of the piezoelectric member 2A. A second wire 55b is also routed to a position overlapping with the second extended electrode 46b1, when viewed in plan view.

The first and second extended electrodes 46a1 and 46b1 and the first and second wires 55a and 55b are bonded by a sheet-shaped adhesive 54. The sheet-shaped adhesive 54 according to the second variation preferably has anisotropic conductivity. More specifically, the sheet-shaped adhesive 54 is conductive only in a thickness direction, or in other words, in the z direction. Accordingly, the first extended electrode 46a1 and the first wire 55a are electrically connected. The second extended electrode 46b1 and the second wire 55b are electrically connected.

On the other hand, the sheet-shaped adhesive 54 is not conductive in a direction parallel to the x-y plane. Accordingly, the first extended electrode 46a1 and the first wire 55a are not electrically connected to the second extended electrode 46b1 and the second wire 55b.

Note that the sheet-shaped adhesive 54 may have a conductor passing therethrough in the thickness direction, for example. The above-described anisotropic conductivity is able to be achieved as a result.

According to the second variation, the first package member 3 and the piezoelectric element 2 are bonded at one location using the sheet-shaped adhesive 54. As such, the device is not susceptible to the effects of noise caused by bending or other deformation of the first package member 3.

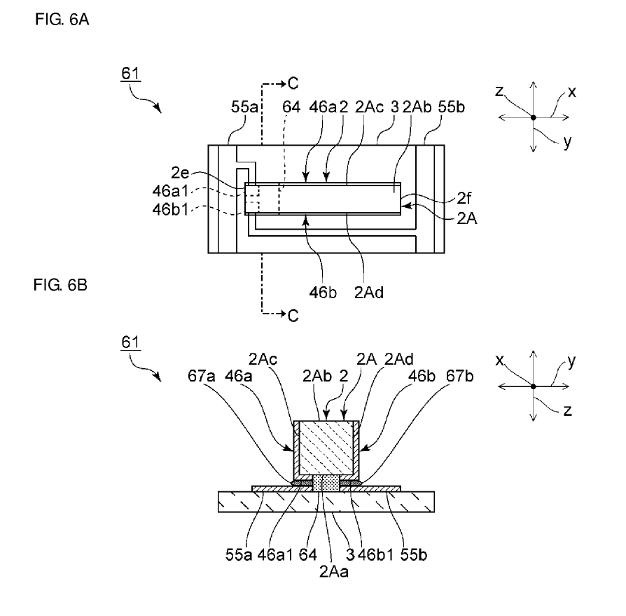

FIG. 6A is a plan view of an acceleration detection device according to the third variation of the first preferred embodiment. FIG. 6B is a cross-sectional view of the acceleration detection device, viewed along the line C-C in FIG. 6A.

Similarly to the second variation, an acceleration detection device 61 includes the first and second extended electrodes 46a1 and 46b1. As illustrated in FIGS. 6A and 6B, the first extended electrode 46a1 and the first wire 55a are electrically connected by a bump 67a. The second extended electrode 46b1 and the second wire 55b are electrically connected by a bump 67b.

A sheet-shaped adhesive 64 is provided on a portion of the bottom surface 2Aa of the piezoelectric member 2A where the first and second extended electrodes 46a1 and 46b1 are not provided.

Returning to FIGS. 1B and 1C, the sheet-shaped adhesive preferably extends to the first end portion 2e of the piezoelectric element 2. As described above, however, the sheet-shaped adhesive 4 is not absolutely required to extend to the first end portion 2e. Adjusting the position of the sheet-shaped adhesive 4 makes it possible to adjust the distance between the portion of the piezoelectric element 2 that is supported and the second end portion 2f corresponding to the free end. This makes it possible to adjust the sensitivity of the acceleration detection device 1.

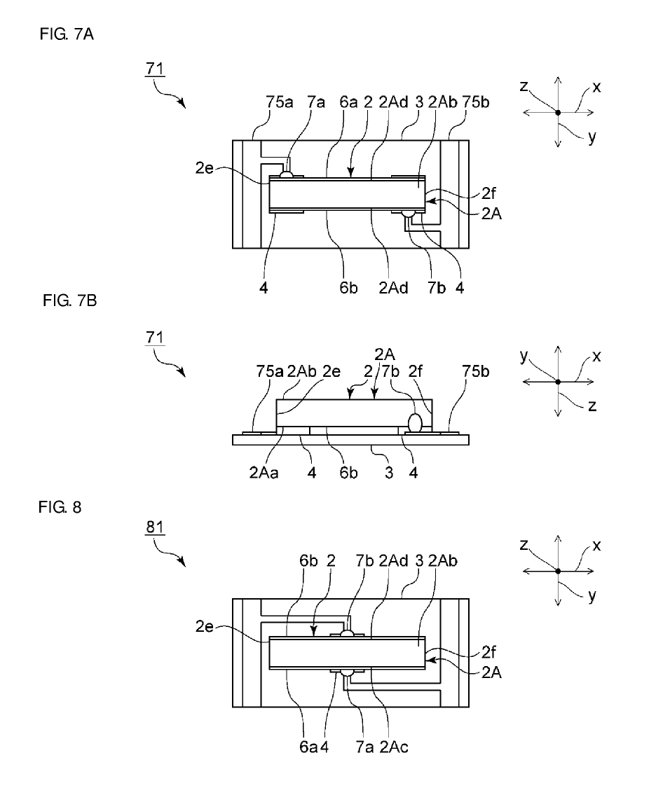

Preferred embodiments of the present invention may be favorably applied in acceleration detection devices aside from those in which the piezoelectric element is supported in a cantilever state. For example, in an acceleration detection device 71 according to a fourth variation, illustrated in FIGS. 7A and 7B, both ends of the piezoelectric element 2 in the longitudinal direction may preferably be supported.

More specifically, the acceleration detection device 71 includes a sheet-shaped adhesive 4 extending to the first end portion 2e. The acceleration detection device 71 also includes a sheet-shaped adhesive 4 extending to the second end portion 2f. The piezoelectric element 2 is supported on both sides by the sheet-shaped adhesives 4 provided in two locations. Note that the sheet-shaped adhesive 4 is not absolutely required to extend to the first and second end portions 2e and 2f of the piezoelectric element 2.

The first electrode 6a is connected to a first wire 75a by the conductive adhesive 7a at a position overlapping with the sheet-shaped adhesive 4, when viewed in plan view from the top surface 2Ab side of the piezoelectric element 2. Likewise, the second electrode 6b is connected to a second wire 75b by the conductive adhesive 7b at a position overlapping with the sheet-shaped adhesive 4, when viewed in plan view. The first and second electrodes 6a and 6b and the first and second wires 75a and 75b are electrically connected as a result.

Also in this case, the position and holding angle of the piezoelectric element 2 do not easily shift, and the element is not susceptible to the effects of noise.

The piezoelectric element 2 may be supported by the sheet-shaped adhesive 4 near the center in the longitudinal direction, or in other words, the x direction, as in an acceleration detection device 81 according to a fifth variation illustrated in FIG. 8. The same or similar effects as in the first preferred embodiment are able to be obtained in this case as well.

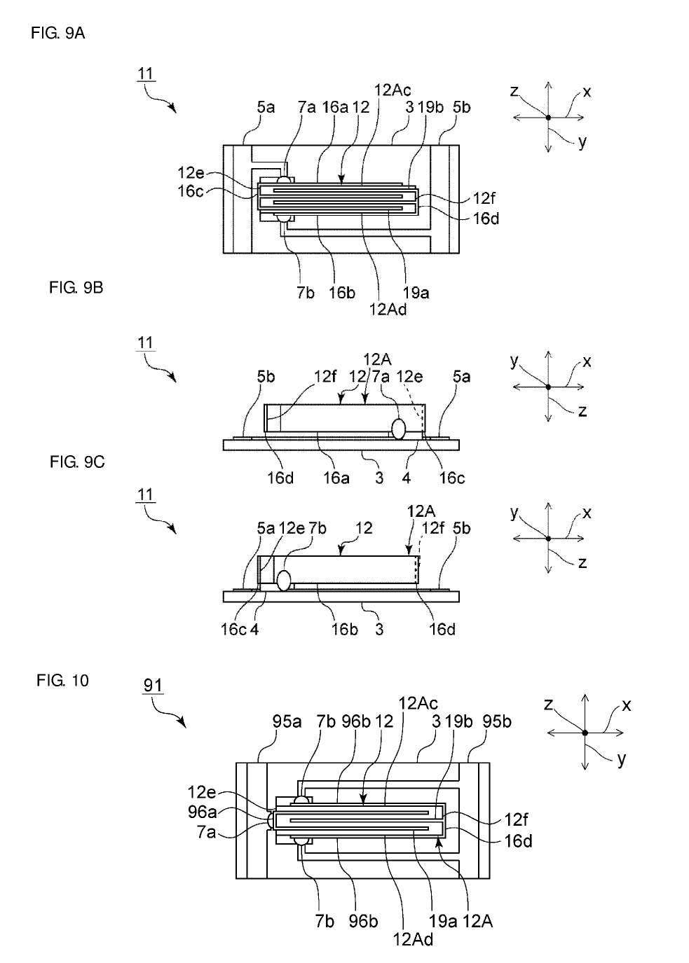

FIG. 9A is a plan view of an acceleration detection device according to a second preferred embodiment of the present invention. FIG. 9B is a diagram illustrating the acceleration detection device from the side of a first side surface of a piezoelectric member, according to the second preferred embodiment. FIG. 9C is a diagram illustrating the acceleration detection device from the side of a second side surface of the piezoelectric member, according to the second preferred embodiment.

An acceleration detection device 11 includes a plurality of first and second inner electrodes 19a and 19b that are provided within a piezoelectric element 12 and oppose each other. The piezoelectric element 12 includes a multilayer body of piezoelectric members. Aside from these points, the acceleration detection device 11 has the same or substantially the same configuration as the acceleration detection device 1 according to the first preferred embodiment. Note that at least one each of the first and second inner electrodes 19a and 19b may be provided.

As illustrated in FIG. 9A, the plurality of first and second inner electrodes 19a and 19b also oppose first and second electrodes 16a and 16b. The plurality of first inner electrodes 19a and the first electrode 16a are extended to a first end portion 12e of the piezoelectric element 12. A first connection electrode 16c is provided on the first end portion 12e. The plurality of first inner electrodes 19a and the first electrode 16a are electrically connected by the first connection electrode 16c. The plurality of second inner electrodes 19b and the second electrode 16b are also extended to a second end portion 12f. A second connection electrode 16d is provided on the second end portion 12f. The plurality of second inner electrodes 19b and the second electrode 16b are electrically connected by the second connection electrode 16d.

The acceleration detection device 11 includes the first and second inner electrodes 19a and 19b, and thus, has a high electrostatic capacitance. This makes it possible to effectively increase the sensitivity.

Furthermore, similarly to the first preferred embodiment, the piezoelectric element 12 is supported by the sheet-shaped adhesive 4 in the present preferred embodiment. Accordingly, the position and holding angle of the piezoelectric element 12 do not easily shift, and the element is not susceptible to the effects of noise.

In the present preferred embodiment, the total number of the first and second inner electrodes 19a and 19b is preferably an even number. The number of layers in the piezoelectric element 12 is preferably an odd number. However, as indicated by an acceleration detection device 91 according to a first variation of the second preferred embodiment illustrated in FIG. 10, the total number of the first and second inner electrodes 19a and 19b may be odd, and the number of layers in the piezoelectric element 12 may be even.

In this case, the manner in which the electrodes are connected is different from the second preferred embodiment. More specifically, a first electrode 96a is provided on the first end portion 12e of the piezoelectric element 12. The first inner electrodes 19a extend to the first end portion 12e, and are physically and electrically connected to the first electrode 96a. Second electrodes 96b are provided on the first and second side surfaces 12Ac and 12Ad of a piezoelectric member 12A. A connection electrode 16d is provided on the second end portion 12f of the piezoelectric element 12. The second electrodes 96b are connected by the connection electrode 16d. Furthermore, the second inner electrodes 19b are also electrically connected to the second electrodes 96b by the connection electrode 16d.

A first wire 95a is electrically connected to the first electrode 96a by the conductive adhesive 7a. A second wire 95b extends towards both the first and second side surfaces 12Ac and 12Ad of the piezoelectric member 12A. The second wire 95b is connected to the second electrodes 96b on both the first and second side surfaces 12Ac and 12Ad by the conductive adhesive 7b. Note that the conductive adhesive 7b may be provided in one location. The second wire 95b is electrically connected to the second electrodes 96b as a result.

Similarly to the second preferred embodiment, the electrostatic capacitance of the acceleration detection device 91 is large in this case as well. This makes it possible to effectively increase the sensitivity. Furthermore, the position and holding angle of the piezoelectric element 12 do not easily shift, and the element is not susceptible to the effects of noise.

In the acceleration detection devices 11 and 91 according to the second preferred embodiment and the first variation, the piezoelectric element 12 is preferably a multilayer body. Note that the first and second inner electrodes 19a and 19b may be embedded in a piezoelectric element including a single-layer piezoelectric member.

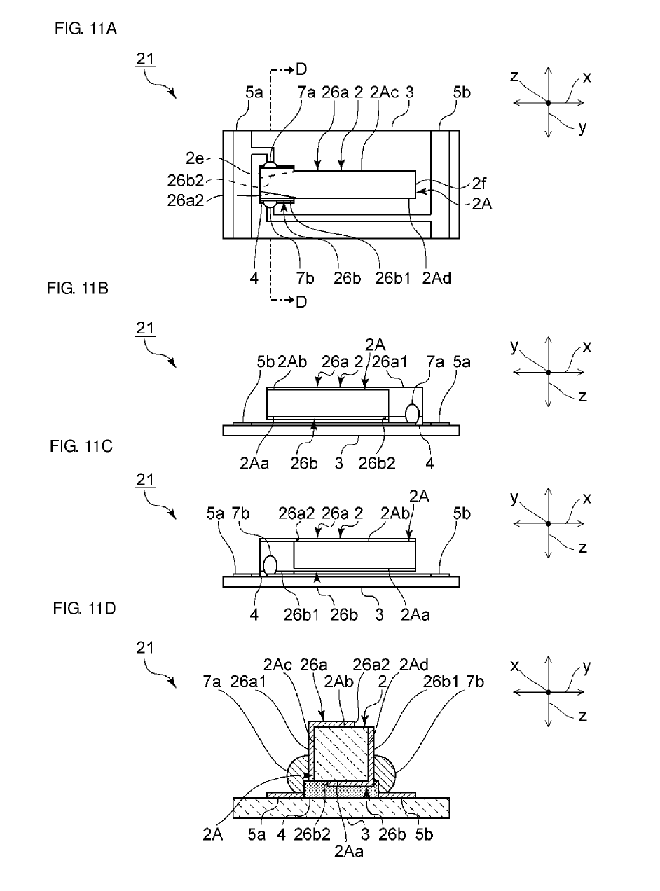

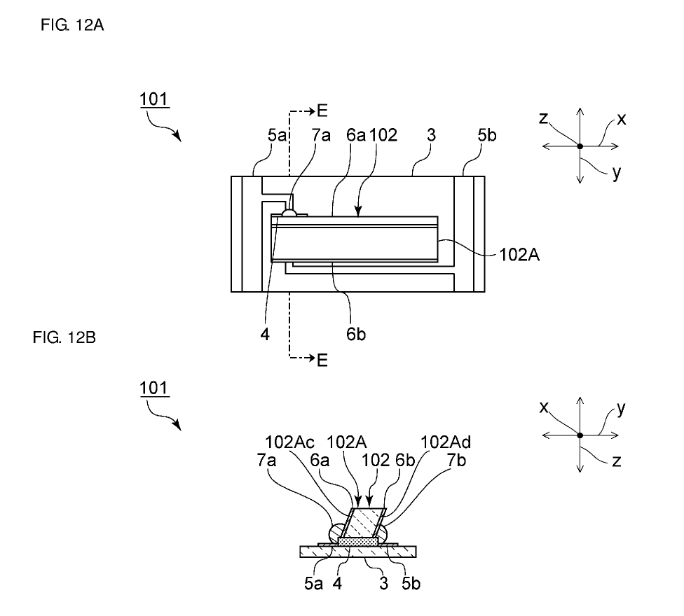

FIG. 11A is a plan view of an acceleration detection device according to a third preferred embodiment of the present invention. FIG. 11B is a diagram illustrating the acceleration detection device from the side of a first side surface of a piezoelectric member, according to the third preferred embodiment. FIG. 11C is a diagram illustrating the acceleration detection device from the side of a second side surface of the piezoelectric member, according to the third preferred embodiment. FIG. 11D is a cross-sectional view of the acceleration detection device, viewed along the line D-D in FIG. 11A.

As illustrated in FIGS. 11B and 11C, in an acceleration detection device 21, a first electrode 26a is provided on the top surface 2Ab of the piezoelectric member 2A. A second electrode 26b is provided on the bottom surface 2Aa of the piezoelectric member 2A. Aside from these points, the acceleration detection device 21 has the same or substantially the same configuration as the acceleration detection device 1 according to the first preferred embodiment.

As illustrated in FIG. 11D, the first electrode 26a includes a first extended electrode 26a1 extended to the first side surface 2Ac of the piezoelectric member 2A. The first extended electrode 26a1 is electrically connected to the first wire 5a by the conductive adhesive 7a. The second electrode 26b also includes a second extended electrode 26b1 extended onto the second side surface 2Ad of the piezoelectric member 2A. The second extended electrode 26b1 is electrically connected to the second wire 5b by the conductive adhesive 7b.

As illustrated in FIGS. 11A and 11C, a cutout portion 26a2 is provided in the first electrode 26a. A gap is provided between the first electrode 26a and the second extended electrode 26b1 as a result. Likewise, as illustrated in FIGS. 11A and 11B, a cutout portion 26b2 is provided in the second electrode 26b as well. A gap is provided between the second electrode 26b and the first extended electrode 26a1 as a result. The first electrode 26a and the second electrode 26b are not electrically connected as a result.

Note that in the present preferred embodiment, it is sufficient for the first electrode 26a and the second electrode 26b to not be electrically connected, and the first and second cutout portions 26a2 and 26b2 are not absolutely required. For example, the first extended electrode 26a1 may be provided so as not to extend to the end portion on the bottom surface 2Aa side of the first side surface 2Ac of the piezoelectric member 2A. The second extended electrode 26b1 may also be provided so as not to extend to the end portion on the top surface 2Ab side of the second side surface 2Ad of the piezoelectric member 2A.

As illustrated in FIGS. 11B to 11D, in the present preferred embodiment, the first and second electrodes 26a and 26b oppose each other with respect to the z direction. In other words, the main axis direction of the acceleration detection device 21 is 90° relative to the x-y plane.

The main axis direction of the acceleration detection device according to various preferred embodiments of the present invention is not limited to 0° or 90° relative to the x-y plane. An example of this will be described below as a sixth variation of the first preferred embodiment.

FIG. 12A is a plan view of an acceleration detection device according to the sixth variation. FIG. 12B is a cross-sectional view of the acceleration detection device, viewed along the line E-E in FIG. 12A.

As illustrated in FIGS. 12A and 12B, first and second side surfaces 102Ac and 102Ad of a piezoelectric member 102A in a piezoelectric element 102 are slanted relative to the z direction. Accordingly, the first and second electrodes 6a and 6b oppose each other with respect to a direction slanted from the y direction and the z direction. In the sixth variation, the main axis direction of an acceleration detection device 101 is a direction, in a y-z plane, that is preferably slanted by about 25° relative to the x-y plane, for example. Note that the main axis direction of the acceleration detection device 101 is not particularly limited.

FIG. 13A is a plan view of an acceleration detection device according to a first variation of the third preferred embodiment. FIG. 13B is a plan view of the acceleration detection device according to the first variation, without the second package member. FIG. 13C is a diagram illustrating the acceleration detection device, without the second package member, from the side of a first side surface of a piezoelectric member, according to the first variation. Note that the dot-dash line F in FIG. 13B indicates a portion where the second package member is bonded.

As illustrated in FIGS. 13A and 13B, an acceleration detection device 111 may preferably include a ground wire 115c1 on a top surface of a first package member 113. The ground wire 115c1 is not particularly limited, but is preferably electrically connected to the second package member 8 by a conductive adhesive.

FIG. 14 is a schematic plan view of the electrode structure on a bottom surface of the first package member 113. A ground terminal 115c2 is provided on the bottom surface of the first package member 113. As illustrated in FIGS. 13A, 13C, and FIG. 14, the ground wire 115c1 is connected to the ground terminal 115c2 on the bottom surface from the top surface of the first package member 113 and via a side surface. When the acceleration detection device 111 is mounted from a bottom surface, the second package member 8 is connected to a ground potential via the ground wire 115c1 and the ground terminal 115c2. In this case, the device is even less susceptible to the effects of electromagnetic noise.

Although not particularly limited, the second package member 8 may be bonded to the first package member 113 using an insulative adhesive at portions aside from those in contact with the ground wire 115c1.

As illustrated in FIG. 13A, first and second wires 115a1 and 115b1 connected to first and second connection electrodes 16c and 16d of a piezoelectric element 112 are provided on the top surface of the first package member 113. Furthermore, a third wire 115a5 is provided on the top surface of the first package member 113. As illustrated in FIG. 14, first, second, and third terminal electrodes 115a2, 115b2, and 115a4, and a third connection electrode 115a3, are provided on the bottom surface of the first package member 113. The first terminal electrode 115a2 and the third terminal electrode 115a4 are connected to the third connection electrode 115a3. The first, second, and third wires 115a1, 115b1, and 115a5 illustrated in FIG. 13A are connected to the first, second, and third terminal electrodes 115a2, 115b2, and 115a4 from the top surface of the first package member 113, via the side surface. The first wire 115a1 is electrically connected to the third wire 115a5 via the first terminal electrode 115a2, the third connection electrode 115a3, and the third terminal electrode 115a4.

As illustrated in FIG. 13C, the piezoelectric element 112 includes a plurality of first and second inner electrodes 119a and 119b opposing each other in the thickness direction. In this manner, a layering direction of the plurality of inner electrodes 119a and 119b may correspond to the thickness direction of the piezoelectric element 112.

As illustrated in FIGS. 13A to 13C, the first package member 113 may preferably include a plurality of recesses, provided in the side surface sides, so as to be opened toward the side surface side and continuous in the thickness direction. The first, second, and third wires 115a1, 115b1, and 115a5 and the ground wire 115c1 are provided along the recesses.

A first connection wire 16c may preferably be connected to the first wire 115a1 by the bonding wire 47a, as in an acceleration detection device 121 according to a second variation illustrated in FIG. 15. Likewise, the second electrode 26b may preferably be connected to a second wire 115b1 by the bonding wire 47b.

FIG. 16 is a side cross-sectional view of an acceleration detection device according to a fourth preferred embodiment of the present invention.

A first package member 33 of an acceleration detection device 31 includes a recess 33a. A second package member 38 preferably has a flat plate shape. Aside from these points, the acceleration detection device 31 has the same or substantially the same configuration as the acceleration detection device 1 according to the first preferred embodiment.

The piezoelectric element 2 is located within the recess 33a of the first package member 33. The second package member 38 is bonded to the first package member 33 so as to cover the recess 33a. Note that as long as the second package member 38 is able to be bonded so as to cover the recess 33a, the shape of the second package member 38 is not particularly limited.

According to the fourth preferred embodiment, the position and holding angle on of the piezoelectric element 2 do not easily shift, and the element is not susceptible to the effects of noise.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An acceleration detection device comprising:
a piezoelectric element including a top surface and a bottom surface;
a sheet-shaped adhesive provided on the bottom surface of the piezoelectric element; and
a first package member to which the piezoelectric element is bonded by the sheet-shaped adhesive.

2. The acceleration detection device according to claim 1, wherein
the piezoelectric element includes a piezoelectric member and first and second electrodes provided on the piezoelectric member; and
the piezoelectric member includes a top surface, a bottom surface, a first side surface, and a second side surface opposing the first side surface.

3. The acceleration detection device according to claim 2, wherein the first electrode is provided on the first side surface of the piezoelectric member, and the second electrode is provided on the second side surface of the piezoelectric member.

4. The acceleration detection device according to claim 2, wherein the first electrode is provided on the bottom surface of the piezoelectric member, and the second electrode is provided on the top surface of the piezoelectric member.

5. The acceleration detection device according to claim 4, wherein the piezoelectric element includes a first extended electrode, connected to the first electrode and provided on the first side surface of the piezoelectric member, and a second extended electrode, connected to the second electrode and provided on the second side surface of the piezoelectric member.

6. The acceleration detection device according to claim 1, wherein
the piezoelectric element has a longitudinal direction, and the top surface and the bottom surface extend in the longitudinal direction; and
the piezoelectric element is fixed by the sheet-shaped adhesive such that the piezoelectric element has a free end in at least one location.

7. The acceleration detection device according to claim 6, wherein the piezoelectric element is supported in a cantilever state by the sheet-shaped adhesive.

8. The acceleration detection device according to claim 7, wherein the sheet-shaped adhesive extends into one end portion of the piezoelectric element in the longitudinal direction of the piezoelectric element.

9. The acceleration detection device according to claim 2, further comprising:
first and second inner electrodes that are provided within the piezoelectric element and that oppose each other.

10. The acceleration detection device according to claim 1, wherein the sheet-shaped adhesive is made of an insulative material.

11. The acceleration detection device according to claim 1, further comprising:
a second package member bonded to the first package member; wherein
the piezoelectric element is sealed by the first and second package members.

12. The acceleration detection device according to claim 11, wherein the first package member has a flat plate shape and the second package member has a cap shape.

13. The acceleration detection device according to claim 11, wherein the first package member has a recess, the piezoelectric element is disposed within the recess, and the second package member covers the recess so as to seal the piezoelectric element.

14. The acceleration detection device according to claim 1, wherein the sheet-shaped adhesive has anisotropic conductivity.

15. The acceleration detection device according to claim 2, further comprising:
a plurality of first inner electrodes and a plurality of second inner electrodes that are provided within the piezoelectric element and that oppose each other.

16. The acceleration detection device according to claim 2, wherein the piezoelectric member is a multilayer piezoelectric member including a plurality of piezoelectric member layers.

17. The acceleration detection device according to claim 3, wherein the piezoelectric element includes a first extended electrode, connected to the first electrode and provided on the bottom surface of the piezoelectric member, and a second extended electrode, connected to the second electrode and provided on the bottom surface of the piezoelectric member.

18. The acceleration detection device according to claim 17, wherein the sheet-shaped adhesive is provided on a portion of the bottom surface of the piezoelectric member at which the first and second extended electrodes are not provided.

19. A method of manufacturing the acceleration detection device according to claim 1, the method comprising:
preparing the piezoelectric element;
affixing the sheet-shaped adhesive to the bottom surface of the piezoelectric element; and
bonding the piezoelectric element to the first package member using the sheet-shaped adhesive.
